(19) United States
(12) Patent Application Publication
(10) Pub. No.: US 2012/0254538 A1
(43) Pub. Date: Oct. 4, 2012

(54) STORAGE APPARATUS AND COMPUTER PROGRAM PRODUCT

(75) Inventors: Seijiro Yoneyama, Tokyo (JP); Tomoya Horiguchi, Tokyo (JP); Kotaro Ise, Tokyo (JP)

(73) Assignee: KABUSHIKI KAISHA TOSHIBA, Tokyo (JP)

(21) Appl. No.: 13/283,905

(22) Filed: Oct. 28, 2011

(30) Foreign Application Priority Data
Mar. 29, 2011 (JP) 2011-072087

(51) Int. Cl. G06F 12/08; G06F 12/00

(52) U.S. Cl. 711/118; 711/154; 711/E12.017; 711/E12.001

(57) ABSTRACT

According to an embodiment, a storage apparatus includes a storage unit configured to store a plurality of pieces of data; a communication unit configured to communicate with a plurality of external devices each of which includes a first cache memory in which at least part of the plurality of pieces of data are stored; a write unit configured to write data into the storage unit when the communication unit receives the write request to write the data transmitted from one of the plurality of external devices; and a controller configured to control the communication unit such that the data is transmitted to another external device different from the one external device that has requested the write request.

### CROSS-REFERENCE TO RELATED APPLICATIONS

This application is based upon and claims the benefit of priority from Japanese Patent Application No. 2011-072087, filed on Mar. 29, 2011; the entire contents of which are incorporated herein by reference.

### FIELD

Embodiments described herein relate generally to a storage apparatus and a computer program product.

### BACKGROUND

Conventionally, there is well known a memory card that includes an interface such as a USB and an SDIO, and a wireless communication interface such as Transfer Jet and IEEE 802.11. Each of a device that communicates with the memory card through the interface such as the USB and the SDIO and a device that communicates with the memory card through the wireless communication interface such as the Transfer Jet and IEEE 802.11 can read and write the data from and in the storage device (device in which the data is stored) of the memory card by accessing the storage device.

Sometimes each of the plural devices that conduct the communication with the memory card includes a cache memory in which at least part of plural pieces of data stored in the storage device of the memory card is stored in order to improve data transfer efficiency. At this point, when one of the devices accesses the memory card to write the data, the device differs from other devices in contents of the pieces of data stored in the cache memories of the devices. That is, unfortunately inconsistency is generated among the pieces of data stored in the cache memories of the devices.

### BRIEF DESCRIPTION OF THE DRAWINGS

FIG. 1 is a view of a system according to an embodiment;

FIG. 2 is a block diagram illustrating a function of the system of the embodiment;

FIG. 3 is a sequence diagram illustrating an example of an operation of the system;

FIG. 4 is a sequence diagram illustrating an example of the operation of the system; and

FIG. 5 is a sequence diagram illustrating an example of the operation of the system.

### DETAILED DESCRIPTION

According to an embodiment, a storage apparatus includes a storage unit configured to store a plurality of pieces of data; a communication unit configured to communicate with a plurality of external devices each of which includes a first cache memory in which at least part of the plurality of pieces of data are stored; a write unit configured to write data into the storage unit when the communication unit receives the write request to write the data transmitted from one of the plurality of external devices; and a controller configured to control the communication unit such that the data is transmitted to another external device different from the one external device that has requested the write request.

Hereinafter, a storage apparatus and a computer program product according to an embodiment will be described in detail with reference to the drawings. In the embodiment, a memory card having a wireless communication function is described as the storage apparatus as an example. However, the storage apparatus is not limited to the memory card.

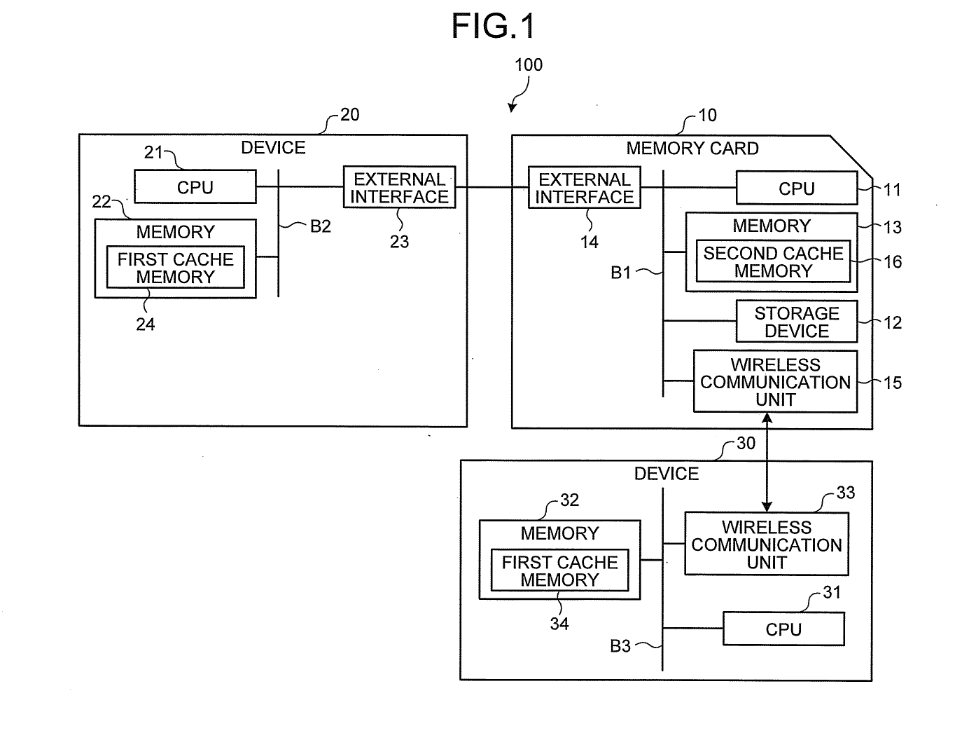

FIG. 1 is a block diagram illustrating an example of a hardware configuration of a system 100 including a memory card 10 and devices 20 and 30. As illustrated in FIG. 1, the memory card 10 includes a CPU 11, a storage device 12, a memory 13, an external interface 14, and a wireless communication unit 15, which are connected to one another through a bus B1.

The CPU 11 controls each unit of the memory card 10. Plural pieces of data used in the devices 20 and 30 are stored in the storage device 12. For example, the storage device 12 includes a nonvolatile semiconductor memory such as a flash memory. For example, the kind of the data may be either image data or text data. In the embodiment, the plural pieces of data stored in the storage device 12 are divided into plural blocks (sectors), and the data can be read or written in units of blocks. Hereinafter one of pieces of data divided into plural blocks is referred to as “file” if needed. It can be understood that the plural files (pieces of data) divided into plural blocks are stored in the storage device 12. The data can be read and written in units of blocks or in units of files.

A control program executed in the memory card 10 and various pieces of data are stored in the memory 13. Any kind of memory can be used as the memory 13. For example, the memory 13 may include either a nonvolatile semiconductor memory such as a ROM (Read Only Memory) or volatile semiconductor memory such as a RAM (Random Access Memory). In the embodiment, in order to improve data transfer efficiency, the memory 13 is configured to include a second cache memory 16 in which at least part of the plural pieces of data stored in the storage device 12 is stored. Either all the plural pieces of data stored in the storage device 12 or only part of the plural pieces of data may be stored in the second cache memory 16.

The external interface 14 controls communication with the device 20 under the control of the CPU 11. For example, the external interface 14 includes a USB or an SDIO. The wireless communication unit 15 controls wireless communication with the device 30 under the control of the CPU 11. For example, the wireless communication unit 15 includes a wireless communication interface such as Transfer Jet and Wi-Fi. The external interface 14 and the wireless communication unit 15 can be understood as a “communication unit” that conducts the communication with plural external devices.

As illustrated in FIG. 1, the device 20 includes a CPU 21, a memory 22, and an external interface 23, which are connected to one another through a bus B2. The CPU 21 controls each unit of the device 20. A control program executed in the device 20 and various pieces of data are stored in the memory 22. In the embodiment, in order to improve the data transfer efficiency, the memory 22 is configured to include a first cache memory 24 in which at least part of the plural pieces of data stored in the storage device 12 is stored. Either all the plural pieces of data stored in the storage device 12 or only part of the plural pieces of data may be stored in the first cache memory 24. The external interface 23 controls the communication with the memory card 10 under the control of the CPU 21. For example, the external interface 23 includes a USB or an SDIO.

As illustrated in FIG. 1, the device 30 includes a CPU 31, a memory 32, and a wireless communication unit 33, which are connected to one another through a bus B3. The CPU 31 controls each unit of the device 30. A control program executed in the device 30 and various pieces of data are stored in the memory 32. In the embodiment, in order to improve the data transfer efficiency, the memory 32 is configured to include a first cache memory 34 in which at least part of the plural pieces of data stored in the storage device 12 is stored. Either all the plural pieces of data stored in the storage device 12 or only part of the plural pieces of data may be stored in the first cache memory 34. The wireless communication unit 33 controls the wireless communication with the memory card 10 under the control of the CPU 31. For example, the wireless communication unit 33 includes a wireless communication interface such as a Transfer Jet and a Wi-Fi.

Any kind of device can be used as the devices 20 and 30. For example, the devices 20 and 30 may include an electronic instrument such as a PC (Personal Computer) and a digital camera.

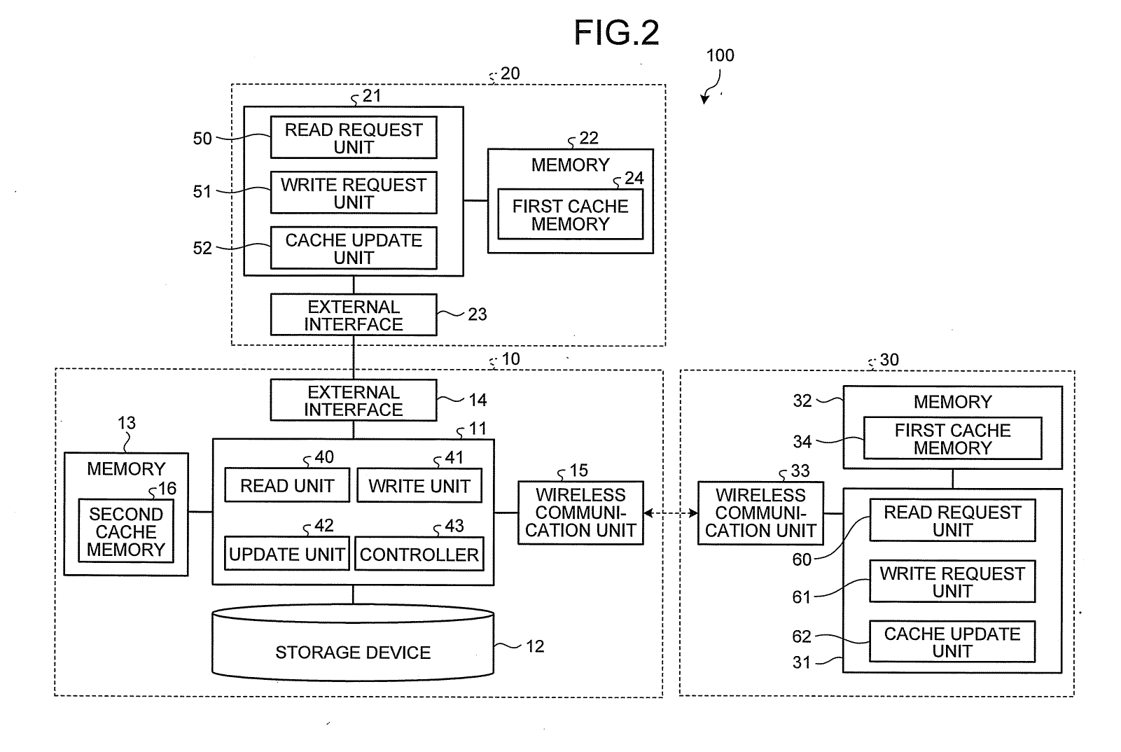

FIG. 2 is a block diagram illustrating functions of the devices 20 and 30. As illustrated in FIG. 2, the functions of the CPU 11 of the memory card 10 include a read unit 40, a write unit 41, an update unit 42, and a controller 43. The functions are implemented such that the CPU 11 reads and executes the control program stored in the memory 13. Alternatively, at least some of the functions may be implemented by an individual circuit (hardware).

In the case that the communication unit (the external interface 14 and the wireless communication unit 15) receives a read request to read one of the plural pieces of data (including the file unit of data and the block unit of data) stored in the storage device 12 from one of the devices 20 and 30, the read unit 40 reads the data of the read request from the storage device 12. Hereinafter, the request to read the file unit of data is referred to as a file read request; and the request to read the block unit of data is referred to as a block read request. The file read request includes file specifying information that specifies the file of the read request; and the block read request includes address information that indicates a position of the block of the read request in the storage device 12. The file read request and the block read request are simply referred to as a read request unless the file read request and the block read request need to be distinguished from each other. In response to the read request, the read unit 40 controls the communication unit such that the communication unit transmits the read data to the device that makes the read request.

In the case that the communication unit receives the write request to write one of the pieces of data (including the file unit of data and the block unit of data) stored in the storage device 12 from one of the devices 20 and 30, the write unit 41 writes the data of the write request into the storage device 12. Hereinafter, the request to write the file unit of data is referred to as a file write request, and the request to write the block unit of data is referred to as a block write request. The file write request includes file specifying information that specifies the file of the data write request, and the block write request includes address information on the block of the data write request. The file write request and the block write request are simply referred to as a write request unless the file write request and the block write request need to be distinguished from each other.

In the case that, in the plural pieces of data (including the file unit of data and the block unit of data) stored in the storage device 12, the data corresponding to the data stored in the second cache memory 16 is updated by the write of the write unit 41, the update unit 42 updates the second cache memory 16 according to the write result. For example, in the case that a “file A” stored in each of the storage device 12 and the second cache memory 16 is updated by the write of the write unit 41, the update unit 42 updates the “file A” stored in the second cache memory 16 with a post-write “file A”.

In the case that the data is written by the write unit 41, the controller 43 controls the communication unit 15 such that the written data is transmitted to the device other device except the device that makes the write request (the other device being different from the device that transmits the write request). The controller 43 notifies the devices 20 and 30 according to access authority (referred to as “permission”) that the device has. Detailed contents are described later.

As illustrated in FIG. 2, functions of the CPU of the device 20 include a read request unit 50, a write request unit 51, and a cache update unit 52. The functions are implemented such that the CPU 21 reads and executes the control program stored in the memory 22. Alternatively, at least some of the functions may be implemented by an individual circuit (hardware).

The read request unit 50 controls the external interface 23 such that the external interface 23 makes the read request to the memory card 10. In the embodiment, the file read request is made according to a protocol such as a FTP, and the block read request is made according to a standard such as a SCSI.

The write request unit 51 controls the external interface 23 such that the external interface 23 makes the write request to the memory card 10. In the embodiment, the file write request is made according to the protocol such as the FTP, and the block write request is made according to the standard such as the SCSI.

In the case that the external interface 23 receives the data that is written by the device 30, the cache update unit 52 updates the data corresponding to the received data in the plural pieces of data stored in the first cache memory 24 with contents of the received data. For example, in the case that the “file A” is written by the device 30 while the “file A” exists in each of the storage device 12 and the first cache memory 24, the controller 43 of the memory card 10 transmits the post-write “file A” to the device 20. In the case that the external interface 23 receives the post-write “file A”, the cache update unit 52 of the device 20 updates the “file A” stored in the first cache memory 24 with the received “file A”.

In the case that the write request unit 51 makes the write request, the cache update unit 52 updates the data of the write request in the plural pieces of data stored in the first cache memory 24 in response to the write request. For example, in the case that the write request unit 51 makes the request to write the “file A”, the cache update unit 52 updates contents of the “file A” stored in the first cache memory 24 with the data that is written in response to the write request.

As illustrated in FIG. 2, functions of the CPU 31 of the device 30 include a read request unit 60, a write request unit 61, and a cache update unit 62. The functions are implemented such that the CPU 31 reads and executes the control program stored in the memory 32. Alternatively, at least some of the functions may be implemented by an individual circuit (hardware). The read request unit 60 has the same function as the read request unit 50, the write request unit 61 has the same function as the write request unit 51, and the cache update unit 62 has the same function as the cache update unit 52. Therefore, the detailed descriptions are omitted.

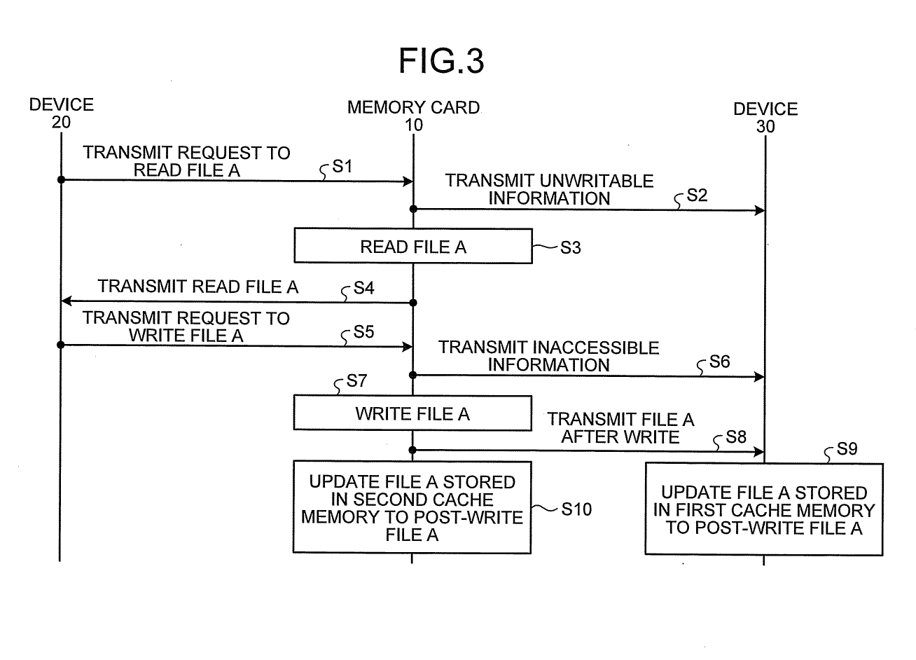

FIG. 3 is a sequence diagram illustrating an example of a specific operation of the system 100 in the case that the device 20 accesses the memory card 10 in units of files. In the embodiment, assuming that the “file A” exists in each of the first cache memory 24 of the device 20, the storage device 12 of the memory card 10, the second cache memory 16 of the memory card 10, and the first cache memory 34 of the device 30, described with be an example of the operation in the case that the device 20 makes the file read request to read the “file A” to the memory card 10 (hereinafter referred to as a “file A read request”), and an example of the operation in the case that the device 20 makes the file write request to write the “file A” in units of files to the memory card 10 (hereinafter referred to as a “file A write request”).

First described will be the example of the operation in the case that the device 20 makes the file A read request to the memory card 10. As illustrated in FIG. 3, the read request unit 50 of the device 20 controls the external interface 23 such that the external interface 23 makes the file A read request to the memory card 10 (Step S1). In the case that the external interface 14 receives the file A read request, the controller 43 of the memory card 10 controls the wireless communication unit 15 such that the wireless communication unit 15 transmits unwritable information indicating that the write request (including the file write request and the block write request) is not received to the device 30 (Step S2). The read unit 40 of the memory card 10 reads the “file A” that is requested by the file A read request to read out from the storage device 12 (Step S3). The read unit 40 controls the external interface 14 such that the read unit 40 transmits the read “file A” to the device 20 in response to the file A read request (Step S4).

Then described will be the example of the operation in the case that the device 20 makes the file A write request to the memory card 10. As illustrated in FIG. 3, the write request unit 51 of the device 20 controls the external interface 23 such that the external interface 23 transmits the file A write request to the memory card 10 (Step S5). At this point, the cache update unit 52 of the device 20 updates contents of the “file A” stored in the first cache memory 24 to the data that is written in response to the file A write request. In the case that the external interface 14 receives the file A write request, the controller 43 of the memory card 10 controls the wireless communication unit 15 such that the wireless communication unit 15 transmits inaccessible information indicating that both the write request and the read request (including the file write request and the block write request) should not be received to the device 30 (Step S6).

The write unit 41 of the memory card 10 writes the data in units of files in the “file A” stored in the storage device 12 (Step S7). The controller 43 of the memory card 10 controls the wireless communication unit 15 such that the wireless communication unit 15 transmits the “file A” that is already written by the write unit 41 to the device 30 (Step S8). In the case that the wireless communication unit 33 receives the post-write “file A”, the cache update unit 62 of the device 30 updates the “file A” stored in the first cache memory 34 with the post-write “file A” (Step S9). Therefore, consistency between the “files A” stored in the first cache memory 24 of the device 20 and the first cache memory 34 of the device 30 can advantageously be achieved.

The update unit 42 of the memory card 10 updates the file A stored in the second cache memory 16 with the post-write file A (Step S10). Therefore, the consistency among the pieces of data stored in the first cache memory 24 of the device 20, the second cache memory 16 of the memory card 10, and the first cache memory 34 of the device 30 can advantageously be maintained.

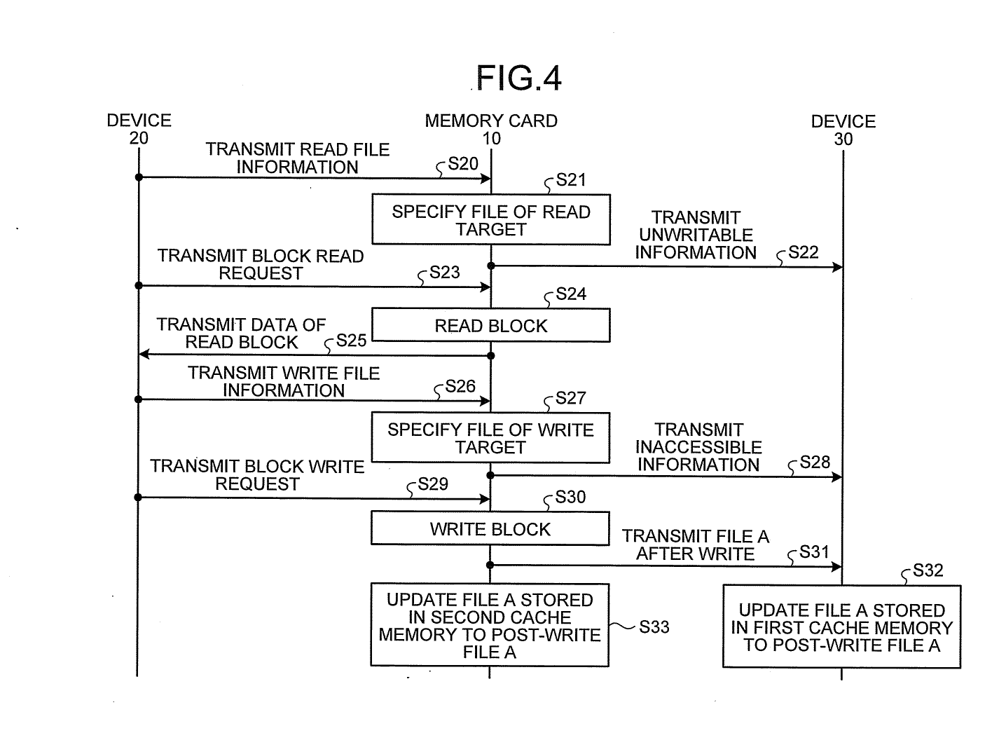

FIG. 4 is a sequence diagram illustrating an example of a specific operation of the system 100 in the case that the device 20 accesses the memory card 10 in units of blocks. Described below will be an example of the operation in the case that the device 20 makes the block read request to read a predetermined block belonging to the “file A” to the memory card 10, and an example of the operation in the case that the device 20 transmits the block write request to write a predetermined block belonging to the “file A” to the memory card 10. First the example of the operation in the case that the device 20 transmits the block read request to the memory card 10 will be described.

As described above, because the block read request includes the address information on the block of the read request, the memory card 10 (read unit 40) that receives the block read request can specify the position of the block of the read request in the storage device 12. However, another piece of processing is required to specify the file to which the block belongs, and it is difficult to immediately specify the file to which the block belongs. In the embodiment, as illustrated in FIG. 4, the read request unit 50 of the device 20 controls the external interface 23 such that the external interface 23 transmits read file information indicating the file of the read target to the memory card 10 before transmitting the block read request (Step S20). The read request unit 50 controls the external interface 23 such that the external interface 23 transmits the read file information indicating that the “file A” is the file of the read target to the memory card 10. In the case that the external interface 14 receives the read file information, the read unit 40 of the memory card 10 refers to the read file information to specify the file of the read target (Step S21). The read unit 40 specifies the “file A” as the file of the read target.

The controller 43 of the memory card 10 controls the wireless communication unit 15 such that the wireless communication unit 15 transmits the unwritable information indicating that the write request is not received to the device 30 (Step S22). The read request unit 50 of the device 20 controls the external interface 23 such that the external interface 23 transmits the block read request to the memory card 10 (Step S23). The read unit 40 of the memory card 10 reads the data of the block specified by the address information included in the block read request in the plural blocks belonging to the “file A” that is of the file of the read target from the storage device 12 (Step S24). The read unit 40 controls the external interface 14 such that the external interface 14 transmits the data of the read block to the device 20 in response to the block read request (Step S25).

Described will be the example of the operation in the case that the device 20 transmits the block write request to the memory card 10. Similarly to the read request in units of blocks, the write request unit 51 of the device 20 controls the external interface 23 such that the external interface 23 transmits write file information indicating the file of the write target to the memory card 10 before transmitting the block write request (Step S26). The write request unit 51 controls the external interface 23 such that the external interface 23 transmits the write file information indicating that the “file A” is the file of the write target to the memory card 10. In the case that the external interface 14 receives the write file information, the write unit 41 of the memory card 10 refers to the write file information to specify the file of the write target (Step S27). The write unit 41 specifies the “file A” as the file of the write target.

The controller 43 of the memory card 10 controls the wireless communication unit 15 such that the wireless communication unit 15 transmits the inaccessible information indicating that both the write request and the read request are not received to the device 30 (Step S28).

The write request unit 51 of the device 20 controls the external interface 23 such that the external interface 23 transmits the block write request to the memory card 10 (Step S29). At this point, the cache update unit 52 of the device 20 updates contents of the “file A” that is of the write target stored in the first cache memory 24 in response to the block write request. More specifically, the cache update unit 52 updates contents of the block specified by the address information included in the block write request in the plural blocks included in the “file A” stored in the first cache memory 24 with the data that has been written in response to the block write request.

The write unit 41 of the memory card 10 writes the data of the block specified by the address information included in the block write request in the plural blocks belonging to the “file A” that is of the file of the write target (Step S30). The controller 43 of the memory card 10 controls the wireless communication unit 15 such that the wireless communication unit 15 transmits the “file A” that is already written by the write unit 41 to the device 30 (Step S31). In the case that the wireless communication unit 33 receives the post-write “file A”, the cache update unit 62 of the device 30 updates the “file A” stored in the first cache memory 34 with the post-write “file A” (Step S32). Therefore, the consistency between the “files A” stored in the first cache memory 24 of the device 20 and the first cache memory 34 of the device 30 can advantageously be maintained.

The update unit 42 of the memory card 10 updates the file A stored in the second cache memory 16 with the post-write file A (Step S33). Therefore, the consistency among the pieces of data stored in the first cache memory 24 of the device 20, the second cache memory 16 of the memory card 10, and the first cache memory 34 of the device 30 can advantageously be maintained.

In the embodiment, the access authority (permission) to each of the plural files stored in the storage device 12 of the memory card 10 is individually set in each device. For example, permission of a specific device relating to a predetermined file is set such that the read request is always permitted, which allows a delay of the access from the specific device to the predetermined file to be avoided. As an example, it is assumed that the permission of the device 20 relating to a “file B” stored in the storage device 12 is set such that both the read request and the write request are always permitted; and it is assumed that the permission of the device 30 relating to the “file B” is set such that the read request is always permitted while the write request is not permitted. The permission of each device can arbitrarily be changed.

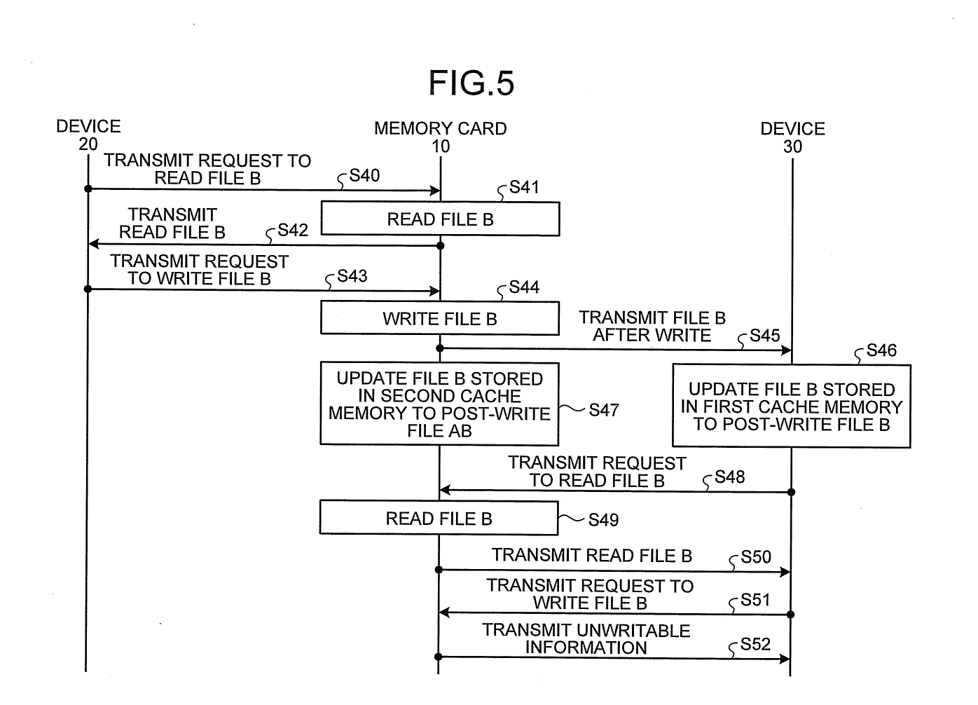

FIG. 5 is a sequence diagram illustrating an example of a specific operation of the system 100 in the case that the devices 20 and 30 access the “file B”. Described will be an example of the operation in the case that the device 20 transmits the file read request to read the “file B” to the memory card 10 (hereinafter referred to as a “file B read request”); an example of the operation in the case that the device 20 transmits the file write request to write the “file B” in units of files to the memory card 10 (hereinafter referred to as a “file B write request”); an example of the operation in the case that the device 30 transmits the file B read request to the memory card 10; and an example of the operation in the case that the device 30 transmits the file B write request to the memory card 10.

First described will be the example of the operation in the case that the device 20 transmits the file B read request to the memory card 10. As illustrated in FIG. 5, the read request unit 50 of the device 20 controls the external interface 23 such that the external interface 23 transmits the file B read request to the memory card 10 (Step S40). As described above, because the permission of the device 30 relating to the “file B” is set such that the read request is always permitted while the write request is not permitted, it is not necessary that the controller 43 of the memory card 10 control the wireless communication unit 15 such that the wireless communication unit 15 transmits unreadable information indicating that the read request (including the file write request and the block write request) and the unwritable information are not received to the device 30.

The read unit 40 of the memory card 10 reads the “file B” that is requested by the file B read request from the storage device 12 (Step S41). The read unit 40 controls the external interface 14 such that the external interface 14 transmits the read “file B” to the device 20 in response to the file B read request (Step S42).

Then described will be the example of the operation in the case that the device 20 transmits the file B write request to the memory card 10. As illustrated in FIG. 5, the write request unit 51 of the device 20 controls the external interface 23 such that the external interface 23 transmits the file B write request to the memory card 10 (Step S43). As described above, because the permission of the device 30 relating to the “file B” is set such that the read request is always permitted while the write request is not permitted, it is not necessary that the controller 43 of the memory card 10 control the wireless communication unit 15 such that the wireless communication unit 15 transmits the unreadable information and the unwritable information to the device 30. At this point, the cache update unit 52 of the device 20 updates contents of the “file B” stored in the first cache memory 24 with the data that is written in response to the file B write request.

The write unit 41 of the memory card 10 writes the data in units of files in the “file B” (Step S44). The controller 43 of the memory card 10 controls the wireless communication unit 15 such that the wireless communication unit 15 transmits the “file B” that is already written by the write unit 41 to the device 30 (Step S45). In the case that the wireless communication unit 33 receives the post-write “file B”, the cache update unit 62 of the device 30 updates the “file B” stored in the first cache memory 34 with the post-write “file B” (Step S46). The update unit 42 of the memory card 10 updates the “file B” stored in the second cache memory 16 with the post-write “file B” (Step S47). Therefore, the consistency among the “files B” stored in the first cache memory 24 of the device 20, the second cache memory 16 of the memory card 10, and the first cache memory 34 of the device 30 can advantageously be maintained.

Described will be the example of the operation in the case that the device 30 transmits the file B read request to the memory card 10. As illustrated in FIG. 5, the read request unit 60 of the device 30 controls the wireless communication unit 33 such that the wireless communication unit 33 transmits the file B read request to the memory card 10 (Step S48). As described above, because the permission of the device 20 relating to the “file B” is set such that the read request and the write request are always permitted, it is not necessary that the controller 43 of the memory card 10 control the external interface 14 such that the external interface 14 transmits the unreadable information and the unwritable information to the device 20.

The read unit 40 of the memory card 10 reads the “file B” that is requested by the file B read request from the storage device 12 (Step S49). The read unit 40 controls the wireless communication unit 15 such that the wireless communication unit 15 transmits the read “file B” to the device 30 in response to the file B read request (Step S50).

Then described will be the example of the operation in the case that the device 30 transmits the file B write request to the memory card 10. As illustrated in FIG. 5, the write request unit 61 of the device 30 controls the wireless communication unit 33 such that the wireless communication unit 33 transmits the file B write request to the memory card 10 (Step S51). As described above, because the permission of the device 30 relating to the “file B” is set such that the read request is always permitted while the write request is not permitted, it is not necessary that the controller 43 of the memory card 10 control the wireless communication unit 15 such that the wireless communication unit 15 transmits the unwritable information to the device 30 (Step S52).

Described above is the example of the operation of the system 100 in the case that each of the devices 20 and 30 accesses the “file B” in units of files. The example of the operation of the system 100 in the case that each of the devices 20 and 30 accesses the “file B” in units of blocks differs from the examples of FIG. 5 in that the read file information is transmitted before the block write request is transmitted and that the write file information is transmitted before the block write request is transmitted.

In the embodiment, the memory card 10 conducts the communication with the two devices. Alternatively, the memory card 10 conducts the communication with at least three devices.

In the embodiment, the device transmits the file read request to the memory card 10 when making the request to read the file stored in the storage device 12 of the memory card 10. Alternatively, for example, the device may transmit the read file information indicating the file of the read target to the memory card 10 before transmitting the file read request.

In the embodiment, the device transmits the file write request to the memory card 10 when making the request to write the data in the file stored in the storage device 12 of the memory card 10. Alternatively, for example, the device may transmit the write file information indicating the file of the write target to the memory card 10 before making the file write request.

In the embodiment, the first cache memory (24 and 34) is included in the memory (22 and 32). Alternatively, the first cache memory (24 and 34) may be provided separately from the memory (22 and 32). Similarly the second cache memory 13 may be provided separately from the memory 13. It is not always necessary to provide the second cache memory 16.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirits of the inventions.

What is claimed is:

1. A storage apparatus comprising:
a storage unit configured to store a plurality of pieces of data;
a communication unit configured to communicate with a plurality of external devices each of which includes a first cache memory in which at least part of the plurality of pieces of data are stored;
a write unit configured to write data into the storage unit when the communication unit receives the write request to write the data transmitted from one of the plurality of external devices; and
a controller configured to control the communication unit such that the data is transmitted to another external device different from the one external device that has requested the write request.

2. The apparatus according to claim 1, further comprising:
a second cache memory configured to store at least part of the plurality of pieces of data stored in the storage unit; and
an update unit configured to update the second cache memory when the data in the storage unit corresponding to the data stored in the second cache memory is updated by the write of the write unit.

3. The apparatus according to claim 1, wherein
the controller controls the communication unit such that the communication unit notifies the plurality of external devices according to access authority for each of the external devices.

4. The apparatus according to claim 1, further comprising
a read unit configured to read data of a read request from the storage unit when the communication unit receives the read request from one of the plurality of external devices to read one of the plurality of pieces of data.

5. A computer program product comprising a computer-readable medium including programmed instructions for controlling a storage apparatus, wherein the instructions, when executed by a computer, cause a computer to perform:
writing data of a write request into a storage unit when the write request to write the data is received,
the write request being requested from one of a plurality of external devices each of which includes a cache memory in which at least part of a plurality of pieces of data; and
transmitting the data written into the storage unit at the writing data to another external device different from the one external device that has requested the write request.
